(19) United States
(12) Patent Application Publication
(10) Pub. No.: US 2009/0064141 A1
(43) Pub. Date: Mar. 5, 2009

(54) EFFICIENT UTILIZATION OF TRANSACTIONS IN COMPUTING TASKS

(75) Inventor: David Wecker, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/846,541

(22) Filed: Aug. 29, 2007

(51) Int. Cl. G06F 9/48

(52) U.S. Cl. 718/100

(57) ABSTRACT

A method of performing a computing transaction is disclosed. In one disclosed embodiment, during performance of a transaction, if an operation in a transaction can currently be performed, then a result for the operation is received from a transaction system. On the other hand, if the operation in the transaction cannot currently be performed, then a message indicating that the operation would fail is received from the transaction system. The transaction ends after receiving for each operation in the transaction a result or a message indicating that the operation would fail.

### BACKGROUND

Transactions find use in a variety of computing device applications, including database operations and parallel processing. Generally, a “transaction” is a grouping of multiple operations into a single “atomic” operation such that the operations are guaranteed to succeed or fail as an entire group. If the transaction succeeds, then all operations proceed. If the transaction fails, then all side-effects of all operations in the transaction are automatically “rolled back” to the point at which the transaction was started, allowing the transaction to be either aborted or restarted. The use of transactions allows multiple programs, services, etc. to read, write to, or otherwise access shared resources without the use of potentially complicated coordination operations such as locks, semaphores, mutexes, etc.

One example of a programming model that may use transactions is the so-called “scatter/gather” model. In this model, a computing task is performed by dividing the task into a plurality of sub-tasks, scattering the sub-tasks to a plurality of workers to perform the sub-tasks in parallel, and then gathering the results from the workers. The scatter and/or gather processes may each be performed within one or more transactions, thereby simplifying the use of shared resources by operations in either of these processes.

However, where two or more parallel operations compete for a resource, their respective transactions could conflict such that one or more of the transactions re-start or abort many times. Where many operations are contained within a transaction, a large number of operations may be performed before the transaction re-starts or aborts. Further, the results from operations in the transaction that could be successfully completed during the transaction are not processed until the transaction concludes. In this manner, a single conflicting operation in a transaction may delay completion of other operations in the transaction that have no conflicts.

One possible way to overcome such issues is by utilizing small, short transactions having fewer numbers of operations to reduce the chances of one conflicting operation causing the re-start or abortion of a large number of operations. However, starting a transaction generally involves allocating memory, initializing data structures, performing various types of bookkeeping, etc., and can be expensive in terms of computing resources. Therefore, the additional overhead created by the use of small transactions may negate any advantages gained by the use of fewer operations in the transactions. Further, splitting a transaction into smaller transactions may lead to incorrect or inconsistent results in some applications, and therefore may be impossible under some circumstances.

### SUMMARY

Accordingly, various embodiments of methods of efficiently utilizing computing transactions are described below in the Detailed Description. For example, in one disclosed embodiment, during performance of a transaction, if an operation in the transaction can currently be performed, then a result is received for the operation, and if the operation in the transaction cannot currently be performed, then a message indicating that the operation would fail is received for the operation. The transaction ends after either a result or a message indicating that the operation would fail is received for each operation in the transaction. In this manner, the transaction is not automatically re-started or aborted if a shared resource utilized by one of the sub-tasks is not available.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a process flow depicting an embodiment of a method of performing a computing transaction.

FIG. 2 shows a schematic diagram depicting an embodiment of a scatter/gather computing method.

FIG. 3 shows a process flow depicting an embodiment of a method for performing a gather transaction in a scatter/gather computing method.

FIG. 4 shows a process flow depicting an embodiment of a method for performing a scatter transaction in a scatter/gather computing method.

### DETAILED DESCRIPTION

Various embodiments of methods of performing computing transactions are disclosed herein that offer the ability for a transaction to proceed even where one or more operations in the transaction cannot be currently performed. It will be appreciated that the terms “computing transaction” and “transaction” are used herein to signify a series of operations that are grouped together and that utilize memory such that the operations may be rolled back to an initial starting point in the event that the transaction is restarted or aborted. Furthermore, the term “transaction system” as used herein may signify any configuration of computing device(s), hardware, software, etc. that handles the execution of a transaction as defined herein.

Current transaction systems are generally configured to automatically roll back a transaction if any operation in the transaction fails. For example, where a read or write operation in a transaction encounters a conflict in accessing a shared resource, the entire transaction will automatically be rolled back upon failure of the read or write. Therefore, in large transactions, many operations may be performed before a rollback occurs. This may cause delays in processing, and also may lead to increased overhead in repeatedly re-opening the transaction after rollback.

One possible way to overcome such a problem in current transaction systems may be to call the transaction system a first time to check whether the shared resource is currently available (but not try to access the resource), such that the transaction returns a result to the requesting program indicating whether the resource is available. If the resource is indicated to be available, the requesting program may again call the transaction system to read/write the shared resource. However, this still leaves open the possibility for another operation to read/write the shared resource between after the first call and before the second call to the transaction system.

To address these issues and others, a transaction system according to the present disclosure has the capability to continue a transaction even where a conflict in accessing a shared resource prevents an operation in the transaction from being performed. The decision of whether to roll-back a transaction can therefore be made by the calling program utilizing higher-level information about the transaction that is not known by the transaction system. For example, if it is important that each operation in the transaction be performed in order, the calling program may call the transaction system in such a manner that the transaction rolls back automatically upon failure of an operation in the transaction. On the other hand, if the order in which the operations are performed is not important, then the calling program may call the transaction system in such a manner that the transaction merely skips the operation that cannot be currently performed and continues with the transaction. The skipped operations may then be performed at a later time once the shared resources used by those operations become available. This is in contrast with current transaction systems, in which an application generally cannot use higher-level information to prevent an automatic rollback even where rollback is not desired.

Prior to proceeding with the description of the Figures, it will be understood that the methods described herein may be implemented on any suitable computing device or devices. As used herein, the term “computing device” may include any device that electronically executes one or more programs. The embodiments described herein may be implemented on one or more computing devices, for example, via computer-executable instructions or code, such as programs, stored on a computer-readable storage medium and executed by the computing device. Generally, programs include routines, objects, components, data structures, and the like that perform particular tasks or implement particular abstract data types. The term “program” as used herein may connote a single program or multiple programs acting in concert, and may be used to denote applications, services, or any other type or class of program.

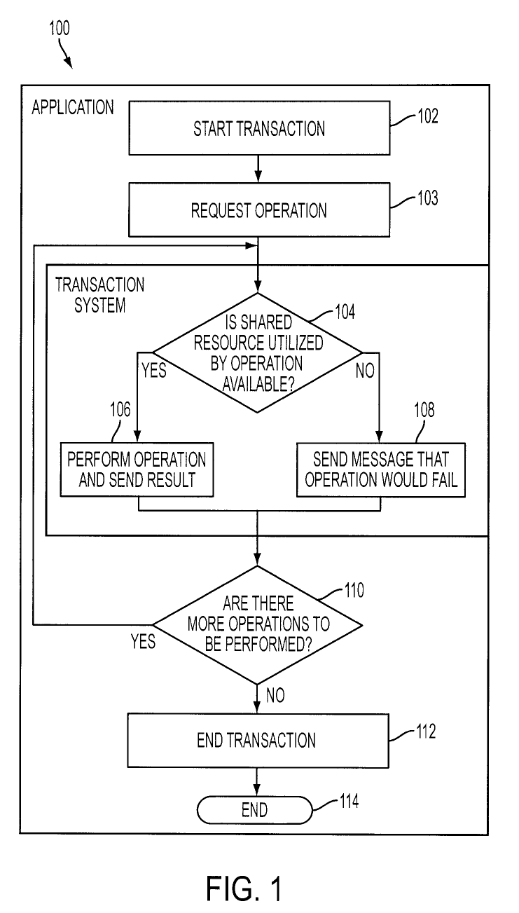

Turning now to FIG. 1, a first embodiment of a method 100 for conducting a computing transaction is shown. The processes are shown from the point of view of a transaction system that performs the transaction. Such a transaction system may be implemented in any suitable manner. For example, a transaction system may be implemented by library files utilized by other programs at runtime. Alternatively, transaction capabilities may be coded directly into a program by a programmer, generated in a program by a compiler, handled by an operating system, coded directly into hardware (for example, as instructions on a processor), etc.

Method 100 comprises, at 102, an application starting a transaction having one or more operations. Starting the transaction may comprise various steps, such as allocating memory, initializing data structures, and other such operations which allow the steps of the transaction to be individually performed, and potentially rolled back, within the transaction before committing the entire transaction. A transaction may be opened, for example, when a request to open a transaction is received from a requesting program.

Next, as depicted at 103, the application requests a transaction system to perform an operation. The transaction system then determines at 10 whether a shared resource utilized by an operation in the transaction is currently available. This determination may be made, for example, by utilizing information that is commonly maintained by a transaction system as part of its state. For example, if an operation in a transaction is a read or write of an item, the transaction system may check if another transaction has read or written the item. Depending upon the specific rules followed by the transaction system regarding conflicting transactions, the transaction system may either read/write the item and send a result of the operation to the requesting program, as indicated at 106, or may send a message that the operation would fail, as indicated at 108.

Method 100 next includes, at 110, determining whether the transaction contains any more operations to perform. If so, then method 100 returns to 10, where the process is performed for the next operation in the transaction. In this manner, the transaction continues until all operations in the transaction have been performed. Once all operations in the transaction have been performed, the transaction ends (i.e. commits all operations) at 112, and the method ends.

In this manner, method 100 may continue to perform additional operations in the transaction even where one or more individual operations in the transaction cannot be performed, for example, due to a conflict in access to one or more shared resources. This allows a program utilizing the transaction to be configured either to roll back (or abort) the transaction upon the occurrence of such a message, or to process the results obtained in the transaction, even if a complete set of results has not yet been received.

Any suitable set of rules may be used to determine how to resolve conflicts in accessing a shared resource in a transaction system. For example, the following rules may be used to determine whether to automatically roll back a transaction in the event of read or write conflicts:
1. If no other transaction has Read/Written the item, then allow the resource to be Read/Written.
2. If another transaction has Read the item and the request is a Read, then allow the resource to be read.
3. If another transaction has Read the item and the request is a Write, then roll back the transaction.
4. If another transaction has Written the item and the request is a Write or a Read, then roll back the transaction.

The transaction system may utilize a similar set of rules to determine when to skip an operation but continue a transaction, as shown below. In this example rule set, the terms “TryRead” and “TryWrite” signify operations in which the transaction system respectively determines and reports whether a shared resource can currently be read or currently be written, but does not automatically roll back a transaction in the event that an access conflict exists.
1. If no other transaction has Read/Written the item, then allow the resource to be Read/Written.
2. If another transaction has Read the item and the request is a TryRead, then allow the resource to be read.
3. If another transaction has Read the item and the request is a TryWrite, then report that the operation would fail.
4. If another transaction has Written the item and the request is a TryWrite or a TryRead, then report that the operation would fail.
   A program receiving the message that the operation would fail can then decide whether to roll back the transaction, to complete the current transaction to the extent possible and then reopen a new transaction to retry the failed operations, or to work with an incomplete set of results, rather than having the transaction automatically rolled back when a failed operation occurs. It will be appreciated that this rule set is shown for the purpose of example, and that any other suitable rule set or sets may be used to determine whether a shared resource can be accessed in the event of a potential access conflict.

In some embodiments, a transaction system may utilize TryRead and TryWrite operations in addition to Read and Write operations. This permits a calling application to utilize Read and Write commands in the transaction where rollback is desired in the event of a failed operation, and to utilize TryRead and TryWrite commands where rollback is not desired. In an alternative embodiment, a transaction system may utilize TryRead and/or TryWrite operations exclusively, rather than Read and/or Write. In these embodiments, the calling application may be configured to make the decision whether to restart or continue a transaction in the event that an operation in the transaction would fail.

The messages returned by the transaction system in response to TryRead/TryWrite operations may have any suitable form. For example, in some embodiments, upon execution of a TryRead command, the transaction system may return a result in the form of a simple two-state flag message (such as a flag) plus a value following the flag. The message indicates whether the read operation could be performed, and the value following the message contains the result in the event that the operation could be performed. Upon receiving such a return from the transaction system, a calling program may first check the message to see if the read operation was successful, and then to read the value after the message only if the message indicates that the operation was successful. Likewise, a TryWrite operation may simply return a message indicating whether the write operation was successful. The calling application may keep track of the operations that were not successful, and may then open another transaction to retry the failed operations. It will be appreciated that this message format is described merely for the purpose of example, and is not intended to be limiting in any manner.

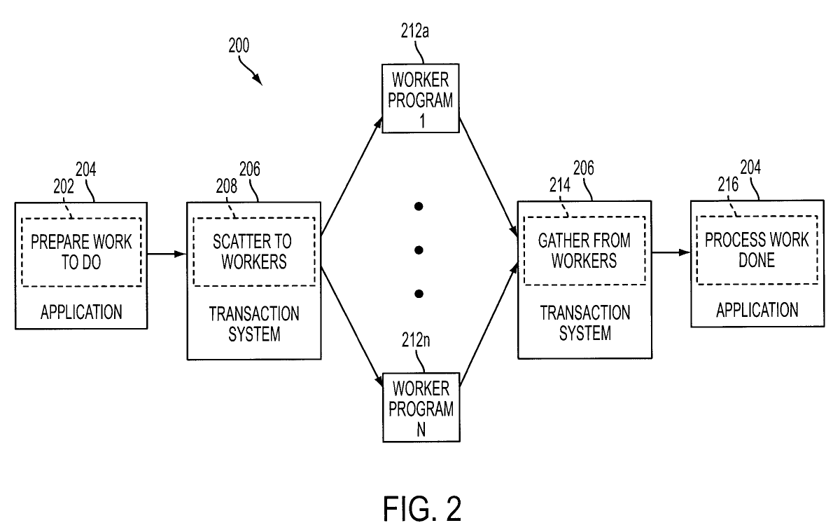

A transaction as described herein may be used in many different environments and applications. For example, as described above, one possible use for transactions in general programming is in the performance of scatter/gather tasks and other parallel processing tasks. FIG. 2 shows a general schematic diagram depicting a scatter/gather computing system and approach. First, as shown at 202, work is prepared into a plurality of smaller work items in an application (or service) program 204 executed via instructions stored on a computing device. The application program 204 then invokes a transaction system 206 to scatter the work items at 208 to a plurality of worker programs (“workers”) to enable the roll back the operations in the scatter transaction under certain conditions. FIG. 2 shows work scattered to N workers 212a-n, where N can be two or more. Next, as indicated at 212, work is gathered from the workers via the transaction system 206 (again utilizing transaction memory to track the operations in the transaction prior to committing the transaction), and the results are processed at 214 by the application program 204. It will be appreciated that the application, transaction system, and worker programs may all be located on a single computing device, or may be located on two or more different computing devices.

Such a scatter/gather approach may be used in many different computer environments. For example, a search program may utilize a plurality of workers each searching different servers, databases, etc. to increase the speed of performing a large search task. Scatter/gather approaches may also be used in distributed computing networks, neural networks, as well as in multi-processor environment, multi-core processor environment, and any other suitable parallel processing and/or distributed computing environment.

Various problems may be encountered with the use of transactions to perform scatter and gather operations. For example, one approach for using transactions to perform a gather operation is as follows:

1. Prepare work to do

2. Scatter work to workers (workers start performing/finishing work)

3. Begin Transaction:
a. For <result>=1 to N do:
   i. Read result from worker <result>
   ii. If not ready, or conflict then re-start Transaction
   iii. Gather the result from this worker
End For

4. End Transaction

5. Process results

In this approach, the results from each worker are gathered via a loop nested within a single transaction. This approach may be inefficient if there is a high degree of conflict, as each conflict results in aborting and restarting the transaction. Furthermore, this approach also leads to the risk of running far into the gather loop before running into a conflict and aborting/restarting the transaction. Additionally, because the transaction does not end until all results have been gathered, no results can be processed until the transaction is complete.

Another approach for performing a gather process via transactions is as follows:

1. Prepare work to do

2. Scatter work to workers (workers start performing/finishing work)

3. For <result>=1 to N do:
a. Begin Transaction:
   i. Read result from worker <result>
   ii. If not ready, or conflict then re-start Transaction
   iii. Gather the result from this worker
b. End Transaction
c. Process this result

4. End For

5. Do any overall processing

In this approach, each result is gathered from each worker in a separate transaction. While this approach allows results to be processed as they are gathered, it also leads to high overhead from starting a minimum of N total transactions. Furthermore, this approach leads to the possibility of getting stuck waiting for one slow worker.

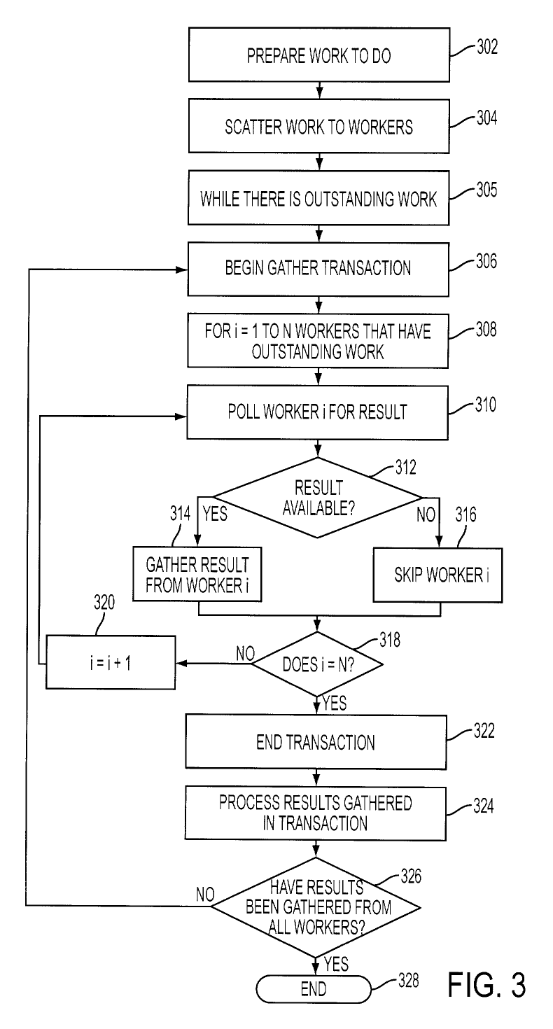

In contrast to these approaches, the use of operations that allow a decision to be made whether to roll back a transaction, such as the example “TryWrite” and “TryRead” operations described above, to conduct gather and/or scatter transactions allows such problems to be avoided. FIG. 3 depicts an embodiment of a method 300 of performing a gather transaction using such concepts. Method 300 comprises, at 302, preparing work to do, and then at 304, scattering the work to workers. Next, at 305, method 300 enters a while loop that loops as long as there is outstanding work, and then begins a gather transaction at 306 within the while loop in which it is attempted to gather work from N workers (wherein i is a counting variable), as indicated at 308 and 310.

In the gather transaction, method 300 attempts to gather a result from each worker that has not provided a result in an immediately prior gather transaction. Therefore, during the first iteration of the “while” loop, all workers are polled, and N is equal to the number of workers to which work was scattered. In later iterations, if any workers were skipped (i.e. no result was gathered from a worker), then N is equal to the total number of workers that have not yet provided a result as of that iteration.

Continuing with FIG. 3, worker is polled for a result at 310. Using the above-described rules, this polling operation may be thought of as a “TryRead” operation in which the transaction attempts to read a result from worker i. If worker i can be read, then the result is gathered from worker i at 314. On the other hand, if worker i cannot be read, then worker i is skipped at 316 (i.e. no result is gathered from worker i, but the transaction is not rolled back).

If is determined at 318 that i<N, then i is increased by one at 320, and the method loops back through 310, 312, and 314 or 316 until all i workers have been polled. If it is determined at 318 that i=N, then it is determined that all workers having outstanding work have been polled, and the gather transaction is ended at 322. Next, any results gathered in the transaction are processed at 324. As used herein, “ending” the transaction signifies committing the transaction so that the steps in the transaction are actually performed and the results become visible to other operations.

Next, it is determined at 326 if any workers having outstanding work were skipped in the transaction. If so, then an additional gather transaction is begun at 306 to attempt to gather results from any workers skipped in the transaction. In the additional gather transaction, each worker skipped in the prior gather transaction is polled for a response at 310, and either a result is gathered at 314 or the worker is skipped at 316, depending upon whether the result can be read from the worker. After all workers have been polled, the additional gather transaction is closed at 322, the results gathered in the additional gather transaction are processed at 324, and it is determined at 326 if results have been gathered from all of the workers. If there is still outstanding work, method 300 iteratively loops back to open additional gather transactions until results have been received from each worker. Once all results have been received, then method 300 ends.

Method 300 offers several advantages over the two other gather transaction methods described above. For example, by simply skipping a worker and continuing gathering rather than restarting the transaction upon the occurrence of a read failure, method 300 allows gathering to occur even where all workers are not available. Also, because the entire transaction is not rolled back when a read failure occurs, resources are not wasted in gathering results before the read failure and then discarding the results by rolling back. Additionally, skipping a worker upon the occurrence of a read failure allows method 300 not to become stuck waiting for slow workers. Further, method 300 may allow fewer total transactions to be used compared to the other methods described above, as the expense of opening more than one transaction only occurs if workers were skipped in a prior gather transaction.

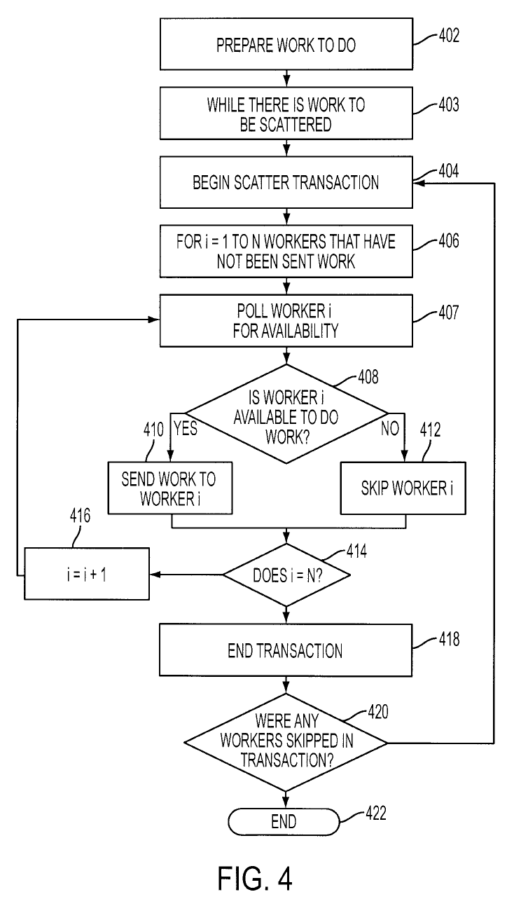

Similar advantages may be realized in scatter transactions as well. FIG. 4 shows an embodiment of a method 400 of performing a scatter transaction in a similar manner as that shown in FIG. 3 for a gather transaction. Method 400 first comprises, at 402, preparing the work to be done as a plurality of work items to be scattered to a plurality of workers. Next, at 403, method 400 enters a while loop that loops as long as there is outstanding work. In the while loop, a scatter transaction is started at 404 to attempt to scatter the plurality of work items to i workers, as indicated at 406.

In the scatter transaction, method 400 attempts to scatter a work item to each worker that has not yet been sent a work item. Therefore, during the first iteration of the “while” loop, N is equal to the number of workers to which work items are to be scattered. In later iterations, if any workers were skipped (i.e. no work scattered to the worker), then N is equal to the total number of workers that have not yet received a work item.

Method 400 next comprises, within the transaction, polling worker i at 407, and then determining at 408 whether worker i is available to do work. Using the above-described rules, the polling operation may proceed as a “TryWrite” operation described above in which the transaction attempts to write to worker i. If worker i is available to do the work, then method 400 comprises, at 410, sending a work item to worker i. On the other hand, if worker i cannot be written to, then method 400 comprises, at 412, skipping worker i (i.e. no work item is sent to worker i, but the transaction is not rolled back).

Method 400 loops through 406, 407, 408, and 410 or 412 until all workers have been polled, as indicated at 414 and 416. Once all workers have been polled, method 400 then comprises ending the scattering transaction at 418, thereby committing the scatter operations to the workers that are available.

Next, it is determined at 440 if all work was scattered, or if any work was not scattered during the scattering transaction. If all work was scattered, then method 400 ends. On the other hand, if any workers were skipped, then an additional scattering transaction is begun at 404 to attempt to scatter work to any workers skipped in the prior transaction. In the additional scattering transaction, each worker skipped in the prior scattering transaction is again polled to see if the worker is available to do work (i.e. a “TryWrite” operation is performed to the worker), and either work is sent to the worker at 410 or the worker is skipped at 412, depending upon whether the work can be written to the worker. After all workers have been polled, the additional scattering transaction is closed at 418, and it is again determined at 420 if all work has been scattered. If there is still work to be scattered, method 400 loops back iteratively to open additional scattering transactions until all work items are distributed. Once work items have been scattered to all workers, then method 400 ends.

Method 400 offers several advantages over distributing work via a scattering transaction in which a failure to write to a worker causes the transaction to roll back. For example, if there is a failure to write to one worker, other workers may still proceed with the work. Likewise, the transaction is not rolled back and restarted due to a failure to write, which may help reduce the expense caused by transactions repeatedly rolling back and restarting due to a high number of conflicts. Further, method 400 may allow fewer total transactions to be used to scatter work compared to methods where a write failure causes an automatic roll back, as the expense of opening more than one transaction only occurs if workers were skipped in a prior gather transaction.

While disclosed herein in the context of scatter/gather operations, it will be appreciated that the disclosed embodiments may also be used in any other suitable context or application, including but not limited to other contexts in which operations contained within transactions access one or more shared resources that pose a risk of conflicting access with other operations.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. A method of performing a computing transaction, the method comprising:
requesting a transaction system to perform a transaction having a plurality of operations;
while the transaction is being performed,
receiving a result for an operation in the transaction if the operation can currently be performed;
receiving a message indicating that the operation would fail if the operation cannot currently be performed; and
ending the transaction after receiving for each operation a result or a message indicating that the operation would fail.

2. The method of claim 1, wherein the transaction is a scatter transaction, and wherein the operation comprises sending work to a worker selected to perform the work.

3. The method of claim 2, wherein the result comprises successfully sending the work to the worker.

4. The method of claim 2, wherein the scatter transaction is a first scatter transaction, and further comprising opening another scatter transaction and sending work to any workers to which work was not sent in the first scatter transaction.

5. The method of claim 1, wherein the transaction is a gather transaction, and wherein the operation comprises gathering a result from a worker which performed previously scattered work.

6. The method of claim 5, wherein the gather transaction is a first gather transaction, and further comprising:
opening an additional gather transaction;
for any operations which could not be performed in the first gather transaction and which currently can be performed, receiving a result;
for any operations which could not be performed in the first gather transaction and which currently can not be performed, receiving a message indicating that the operation would fail; and
closing the additional transaction.

7. The method of claim 1, wherein the operation is a TryRead operation in which the transaction system reports whether a shared resource can currently be read.

8. The method of claim 1, wherein the operation is a TryWrite operation in which the transaction system reports whether a shared resource can currently be written.

9. A method of performing a computing transaction, the method comprising:
dividing the transaction into a plurality of work items to be performed by a plurality of workers;
sending each work item to a corresponding worker to perform the work item; and
gathering results from the workers by:
opening a gather transaction;
polling each worker to determine whether each worker has completed its work item;
gathering results from the workers that have completed their work items;
skipping workers that have not completed their work items;
closing the gather transaction; and
processing results gathered in the gather transaction.

10. The method of claim 9, wherein the gather transaction is a first gather transaction, and if any workers were skipped in the first gather transaction, then further comprising opening an additional gather transaction; gathering a result from each worker that was skipped in the first gather transaction and that has completed its work item; skipping any worker that has not completed its work item; closing the additional gather transaction; and processing results gathered in the additional gather transaction.

11. The method of claim 10, further comprising iteratively opening other gather transactions to gather results from all workers.

12. The method of claim 11, wherein the results gathered during each gather transaction are processed after closing that gather transaction.

13. The method of claim 9, wherein the gather transaction comprises a gathering of search results.

14. A computing device, comprising memory containing executable instructions stored thereon for implementing a transaction system configured to enable the operation of a transaction comprising a plurality of operations, the transaction system comprising:
instructions executable to start the transaction; and
instructions executable to determine whether a shared resource utilized by an operation in the transaction is currently involved in a conflicting operation; if the shared resource utilized by the operation is currently involved in a conflicting operation, then to send a message indicating that the operation would fail; and if the shared resource utilized by the operation is not currently involved in a conflicting operation, then send a result.

15. The transaction system of claim 14, wherein the operation is a TryRead operation requesting the transaction system to report whether a shared resource can currently be read but not to automatically roll back the transaction in the event that an access conflict exists.

16. The transaction system of claim 15, further comprising instructions executable to generate the message if another operation is performing a conflicting write operation.

17. The transaction system of claim 14, wherein the operation is a TryWrite operation requesting the transaction system to report whether a shared resource can currently be written but not to automatically roll back the transaction in the event that an access conflict exists.

18. The transaction system of claim 17, further comprising instructions executable to generate the message if another operation is performing a conflicting read or write operation.

19. The transaction system of claim 14, wherein the operation is a TryRead operation, wherein the message indicating that the operation would fail is a first message, wherein the result is sent as part of a second message, and wherein the first and second messages each comprises a two-state flag and a value in which the flag indicates whether or not the value is the result.

20. The transaction system of claim 14, wherein the operation is a TryWrite operation, and wherein the message and the result each comprises a two-state flag such that the value of the flag indicates whether or not the operation would fail.
